(19) United States
(12) Patent Application Publication
(10) Pub. No.: US 2025/0078197 A1
(43) Pub. Date: Mar. 6, 2025

(54) MODEL OPERATIONS ORCHESTRATOR FOR DIGITAL ASSET PROCESSING

(71) Applicant: Ventana 3D, LLC, Chicago, IL (US)

(72) Inventors: Guzmán MONNÉ, Montevideo (UY); Hayk Bezirganyan, Burbank, CA (US); Ilija Gavran, Zagreb (HR); Kyle James McKinley, Tucson, AZ (US); Jeffrey Christopher Chamberlain, Seattle, WA (US); Ashley Crowder, Sherman Oaks, CA (US); Benjamin Conway, Chicago, IL (US)

(21) Appl. No.: 18/818,469

(22) Filed: Aug. 28, 2024

Related U.S. Application Data
(60) Provisional application No. 63/534,887, filed on Aug. 28, 2023.

(51) Int. Cl. G06T 1/20

(52) U.S. Cl. CPC G06T 1/20

(57) ABSTRACT

According to embodiments herein, a model operations orchestrator for digital asset processing is shown and described that is an efficient tool that streamlines the process of optimizing and converting digital assets, particularly large 3D assets as well as the creation and processing of 2D assets from 3D assets. The orchestrator herein functions as an umbrella for various scripts and provides an interface that makes it easy for users to select and perform tasks on these assets.

### RELATED APPLICATION

This application claims priority to U.S. Prov. Appl. Ser. No. 63/534,887, filed Aug. 28, 2023, entitled MODEL OPERATIONS ORCHESTRATOR FOR DIGITAL ASSET PROCESSING, by, Monné, et al., the contents of which are incorporated herein by reference.

### TECHNICAL FIELD

The present disclosure relates generally to computer graphics, and, more particularly, to a model operations orchestrator for digital asset processing.

### BACKGROUND

While visualization hardware continues to improve, there still remain opportunities to improve the handling of visual data. This holds in a number of contexts, ranging from traditional two-dimensional (2D) television (e.g., ultra-high-definition television), to cellphones, to various virtual reality (VR) and augmented reality (AR) devices, to even holographic representation of some three-dimensional (3D) images. Indeed, many modern displays and cutting-edge holograms now support resolutions beyond what the human eye can perceive.

As a result of the increasing capabilities of visualization hardware, there is also a corresponding increase in the amount of visualization data that needs to be created, managed, and transmitted over a computer network, as well as processed by the endpoint device. This is particularly true in the case visualization data for the rendering of high-quality 3D objects, which can be quite data-intensive. Moreover, there are hundreds of different 3D file types, with each being optimized for its own specific software. Consequently, the process of optimizing, converting, and exporting 3D objects from one file type to another can be complex, difficult, and cumbersome for most users, and can also lead to various issues and degradation of the 3D objects. 3D objects can also be used to render 2D content, which can be a very manual and time consuming process that can lock up a user's computer for a period of time.

### SUMMARY

According to embodiments herein, a model operations orchestrator for digital asset processing is shown and described that is an efficient tool that streamlines the process of optimizing and converting digital assets, particularly large 3D assets as well as the creation and processing of 2D assets from 3D assets. The orchestrator herein functions as an umbrella for various scripts and provides an interface that makes it easy for users to select and perform tasks on these assets.

In one embodiment, an illustrative method herein may comprise: providing a model operations orchestrator configured to function as a communication layer between a plurality of containerized environments, wherein each containerized environment houses one or more modules for performing specific tasks on a digital asset; receiving, by the model operations orchestrator, a definition of an orchestration pipeline, the orchestration pipeline specifying a sequence of tasks to be performed on the digital asset, each task corresponding to a particular module within a particular containerized environment; dynamically loading one or more pipeline modules based on the orchestration pipeline, wherein each pipeline module exposes an interface that allows the model operations orchestrator to provide specific configuration parameters required for execution of a corresponding task for that pipeline module; scheduling, by the model operations orchestrator, execution of the one or more pipeline modules in accordance with the orchestration pipeline, wherein the one or more pipeline modules are executed either sequentially or in parallel based on the sequence of tasks and without collision;

and processing the digital asset through the sequence of tasks as defined in the orchestration pipeline, wherein the digital asset is managed by the model operations orchestrator as a single manifest asset that is handled throughout the orchestration pipeline.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication system;

FIG. 2 illustrates an example device;

FIGS. 3A-3B illustrate example meshes in visualization data;

FIG. 4 illustrates an example curvature;

FIG. 5 illustrates an example pipeline definition;

FIG. 6 illustrates an example of how one might download, optimize, and upload a resulting file;

FIG. 7 illustrates an example of a complete module call;

FIG. 8 illustrates an example simplified architecture of a model operations orchestrator;

FIG. 9 illustrates an example simplified procedure for operation of a model operations orchestrator for digital asset processing.

### DESCRIPTION OF EXAMPLE EMBODIMENTS

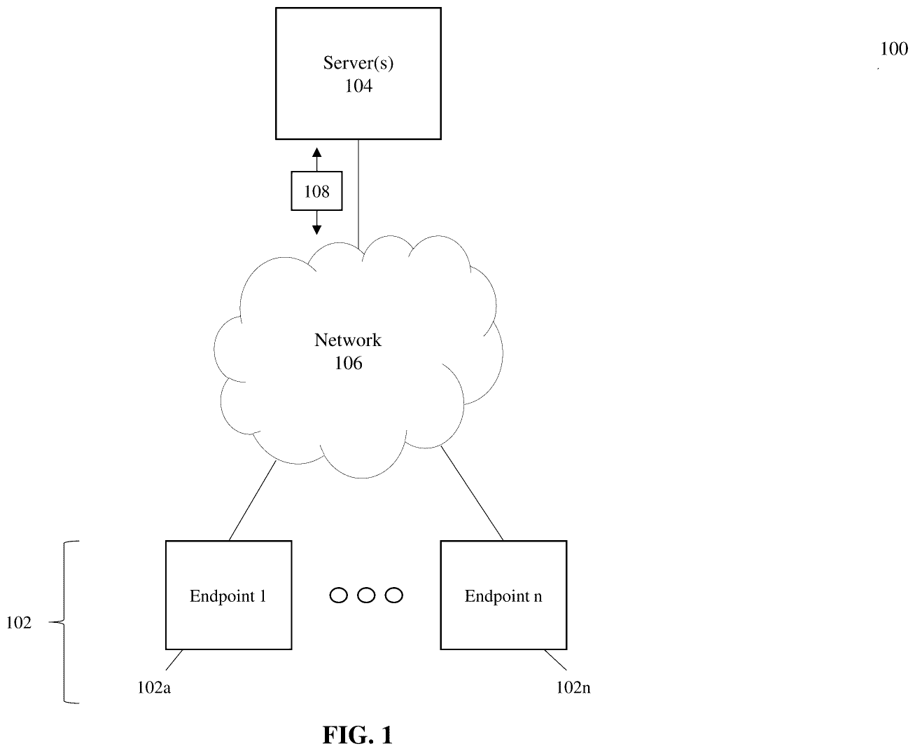

FIG. 1 illustrates an example communication system 100, according to various embodiments. As shown, communication system 100 may generally include n-number of endpoint devices 102 (e.g., a first endpoint device 102a through n^{th} endpoint device 102n) interconnected with one or more servers 104 by a network 106.

In general, endpoint devices 102 may comprise computing devices capable of storing, processing, and communicating data. For instance, endpoint devices 102 may comprise mobile phones, tablets, wearable electronic devices (e.g., smart watches, smart glasses, etc.), desktop computers, or any other known form of device capable of performing the techniques herein.

During operation, endpoint devices 102 and server(s) 104 may be communicatively coupled with one another, either directly or indirectly, such as by leveraging a communication infrastructure that forms network 106. For instance, devices 102 and server(s) 104 may communicate with one another via the Internet or other form of network 106 (e.g., a multiprotocol label switching network, etc.). Accordingly, network 106 may comprise any number of wide area networks (WANs), local area networks (LANs), personal area networks (PANs), and/or direct network connections between any of these components.

More specifically, example network connections and infrastructure of network 106 may include, but are not limited to, connections that leverage wireless approaches such as Wi-Fi, cellular, satellite, and the like, and/or wired approaches such as Ethernet, cable Internet, fiber optics, and the like. In further embodiments, endpoint devices 102 may communicate directly with one another using a shorter-range communication approach, such as via Bluetooth, near field communication (NFC) approaches, infrared, visible light, or the like. In yet another embodiment, one of devices 102 may provide connectivity to network 106 on behalf of the other, essentially acting as a communications relay.

Server(s) 104 may comprise one or more servers that provide a service configured to facilitate the transfer of visualization data 108 between server(s) 104 and endpoint devices 102. Generally speaking, visualization data 108 may take the form of any number of files that, when processed by a receiving endpoint device in endpoint devices 102, causes that endpoint device to render visualization data 108 onto one or more electronic displays associated with the endpoint device. For instance, the endpoint device may display visualization data 108 via an integrated screen, one or more monitors, one or more televisions, one or more virtual reality (VR) or augmented reality (AR) displays, one or more projectors of a hologram system, or the like.

For instance, endpoint device 102a may upload visualization data 108 to a server 104 that is later downloaded by endpoint device 102n and displayed to a user. As noted above, the ever-improving visualization hardware of endpoint devices, such as endpoint devices 102, there is a corresponding increase in the amount of visualization data 108 that needs to be communicated across network 106. In addition, this increase in visualization data 108 will also result in greater resource consumption by the receiving endpoint device 102n. Accordingly, efficiency in data compression and rendering are essential to providing the best possible image and performance with respect to visualization data 108.

Optimizing visualization data 108 can also be quite beneficial with respect to converting and exporting visualization data from one 3D file format into another.

Indeed, there are upwards of hundreds of different 3D file types, each of which is optimized for its own specific software. For instance, Blend uses the BLEND file format, AutoCAD uses the .DWG format, Clo uses the .zprj format, Browzwear uses the .bw format, etc. This causes problems because these proprietary formats cannot be used in other programs. While there are also neutral file formats, such as .FBX, the conversion and extraction of 3D files often leads to issues such as the following:
Flipped normal;
Maps becoming distorted or lost;
Specular/glossy conversion to metal/roughness might only be done partially or not all;
Degenerate or missing polygons; and/or
Excess metadata that inflates the file size.

In addition, attempting to use 3D files on certain platforms such as Facebook, Snapchat, Google Swirl, web AR, etc., can also require the use of a variety of 3D files because each platform has its own file specifications for:
File type;
File size limit;
Texture type; and
Texture size limit.

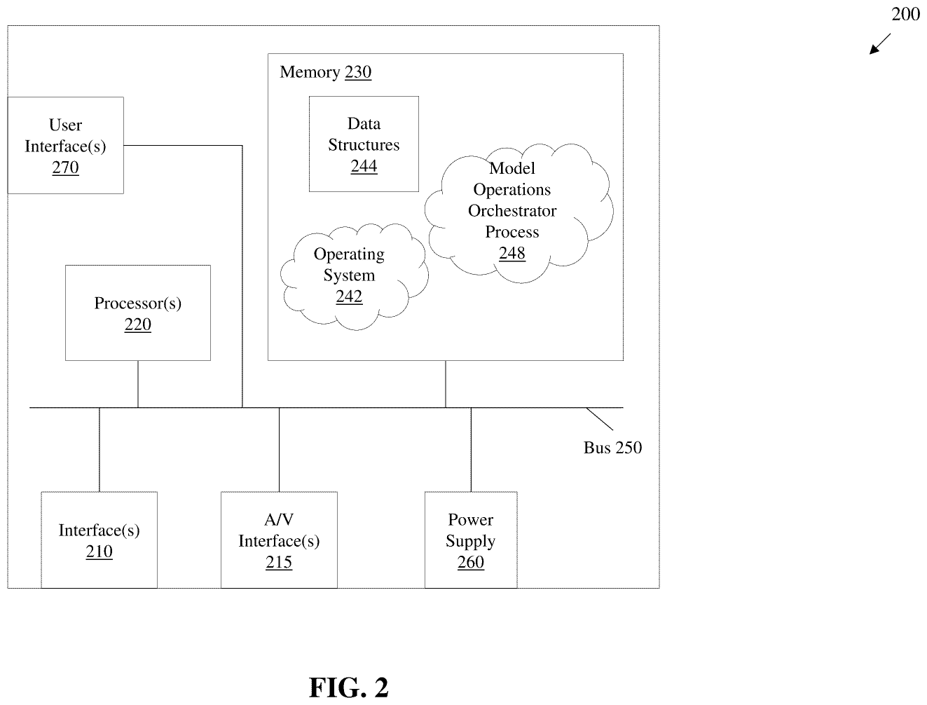

FIG. 2 illustrates an example schematic block diagram of a computing device 200 (e.g., apparatus) that may be used with one or more embodiments described herein, such as any of endpoint devices 102 and/or server(s) 104 shown in FIG. 1, or another device in communication therewith (e.g., an intermediary device). The illustrative device may comprise at least one network interface 210, one or more audio/video (A/V) interfaces 215, at least one processor 220, a memory 230, and user-interface components 270 (e.g., keyboard, monitor, mouse, etc.), interconnected by a system bus 250, as well as a power supply 260. Other components may be added to the embodiments herein, and the components listed herein are merely illustrative.

The network interface(s) 210 contain the mechanical, electrical, and signaling circuitry for communicating data over links coupled to a computer network. A/V interfaces 215 contain the mechanical, electrical, and signaling circuitry for communicating data to/from one or more A/V devices, such as cameras, displays, etc. The memory 230 comprises a plurality of storage locations that are addressable by the processor(s) 220 for storing software programs and data structures associated with the embodiments described herein. The processor(s) 220 may comprise hardware elements or hardware logic adapted to execute the software programs and manipulate the data structures 244. An operating system 242, portions of which are typically resident in memory 230 and executed by the processor, functionally organizes the machine by invoking operations in support of software processes and/or services executing on the machine. These software processes and/or services may comprise an illustrative “model operations orchestrator” process 248, among other processes, according to various embodiments.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, where certain processes have been shown separately, those skilled in the art will appreciate that processes may be routines or modules within other processes.

During execution, model operations orchestrator process 248 may provide functionality related to a model operations orchestrator for digital asset processing described herein, which is an efficient tool that streamlines the process of optimizing and converting digital assets, particularly large 3D assets as well as the creation and processing of 2D assets. As described in greater detail below, the orchestrator herein functions as an umbrella to communicate between different containers and various scripts and provides an interface that makes it easy for users to select and perform a custom sequence of tasks on these assets.

Before delving into the specifics of the techniques herein, an explanation of the terminology used herein is needed. In general, a 3D object may be rendered by representing a particular object, as well as the overall scene, as a series of meshes. More specifically, a ‘scene’ S may be defined as a set of surface meshes Mᵢ as follows:

$$S ≡ \{ {M}_{i} , i = 0 , 1 , … \}$$

Likewise, a surface mesh Mᵢ is defined by a set of polygons Pi:

$${M}_{i} ≡ \{ {P}_{l} , l = 0 , 1 , … \}$$

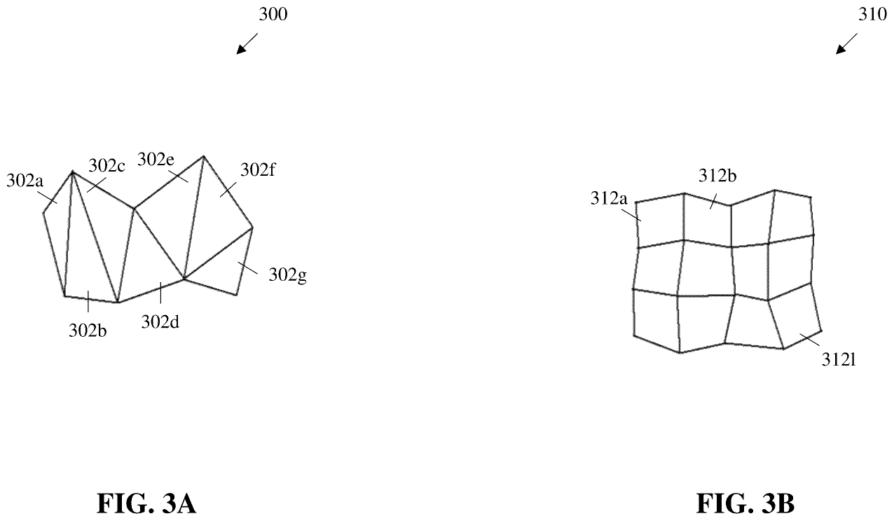

FIGS. 3A-3B illustrate example meshes that may be formed using different types of polygons. More specifically, mesh 300 in FIG. 3A may comprise a set of triangles 302a-30g. Likewise, mesh 310 in FIG. 3B may comprise a set of quadrilaterals 312a, 312b, . . . , 312l. As would be appreciated, different meshes may employ different types of polygons.

Formally, a polygon of a mesh is defined by a set of edges as follows:

$${P}_{l} ≡ \{ {E}_{j} , {E}_{j + 1} , … {E}_{j + n - 1} \} ,$$

where n is the rank of the polygon.

Likewise, edges are defined by two vertices at the two end-points, as follows:

$${E}_{j} ≡ [ {V}_{k} , {V}_{k + 1} ]$$

The geometric location of the vertex Vₖ is given by its position vector: P̅ₖ̅=(xₖ,yₖ,z_{K})

This allows for definition of the tangent of edge Eⱼ, as follows:

$$\overline{{T}_{j}} ≡ ( \overline{{P}_{k + 1}} - \overline{{P}_{k}} ) / ‖ ( \overline{{P}_{k + 1}} - \overline{{P}_{k}} ) ‖$$

where the norm of a vector y is defined in the Euclidean sense,

$$‖ \overline{v} ‖ ≡ \sqrt{{v}_{x}^{2} + {v}_{y}^{2} + {v}_{z}^{2}}$$

By convention, an edge belongs to exactly one polygon, meaning that if two polygons share a side, there will be two collocated edges defined for the two polygons. Similarly, a vertex belongs to exactly one edge, meaning that if multiple edges converge at a single geometric point, there will be multiple collocated vertices defined at that point, one for each edge.

In addition to its position vector P̅ₖ̅, a vertex Vₖ may also have additional properties such as a shading normal N̅ₖ̅^̅{̅S̅}̅, tangent, bi-tangent, as well as a pointer to a UV map. As would be appreciated, UV mapping is a modeling approach whereby a 2D image is projected to the surface of a 3D model, for purposes of texture mapping. Here, the ‘U’ and ‘V’ are used as coordinate axes in the 2D image, whereas ‘X,’ ‘Y,’ and ‘Z’ are used to denote the axes in the 3D space.

Note also that the shading normal N̅ₖ̅^̅{̅S̅}̅ provided at a vertex may or may not be the same as the geometric normal N̅ₖ̅^̅{̅G̅}̅ to the surface in the neighborhood of the vertex. This shading normal N̅ₖ̅^̅{̅S̅}̅ can be thought of as an additional degree of freedom used to specify how to smooth the surface, when reconstructed, as it passes through the vertex.

Given two neighboring edges Eⱼ_{₁}, Eⱼ_{₂}, belonging to the same polygon, the geometric normal at the corresponding vertex Vₖ is:

$$\overline{{N}_{k}^{G}} = ( \overline{{T}_{{j}_{1}}} \times \overline{{T}_{{j}_{2}}} ) / ‖ ( \overline{{T}_{{j}_{1}}} \times \overline{{T}_{{j}_{2}}} ) ‖$$

For vertex categorization, given multiple collocated vertices (at the end-points of edges that converge at a single point), one can compare the shading normal N̅ₖ̅^̅{̅S̅}̅ associated with the individual vertices (located at the same geometric point) as a means of telling whether the vertex is embedded into a smooth surface (i.e., all normals are either identical or very close to each other), is situated on an edge (in which case there will be two distinct normal directions), or is situated on a ‘corner’ (with three or more distinct normal vectors).

An additional way of categorizing a vertex is to compute the geometric normal associated with each pair of edges meeting at the vertex, by taking the vector product between the tangents to those edges.

If the shading normal is regarded as the ‘truth,’ then the differences between the shading normal and the geometrically-determined normal can be used as a measure of the accuracy of the surface representation.

For a vertex Vₖ that is located on a geometric edge (i.e., there are two distinct shading normals) two vertices Vₖ₊, Vₖ₋ can be identified with the most similar shading normals N̅ₖ̅_̅{̅₊̅}̅^̅{̅S̅}̅, N̅ₖ̅_̅{̅_̅{̅−̅}̅}̅^̅{̅S̅}̅ that are directly connected to Vₖ. The tangents to the edges can then be computed as follows:

$${E}_{+} = [ {V}_{k} , {V}_{k +} ] , {E}_{-} = [ {V}_{k -} , {V}_{k} ]$$

Then the curvature of the geometric edge in the neighborhood of the edge will be given by the derivative of the tangent to the curve, which can be estimated via finite differencing:

$${k}_{k} = 2 ‖ \overline{{T}_{+}} - \overline{{T}_{-}} ‖ / ‖ \overline{{P}_{k +}} - \overline{{P}_{k +}} ‖$$

Here, the factor of “2” accounts for the fact that the tangent vectors approximate the edge tangent at its midpoint while the position vectors are the position of the far-side of the edges.

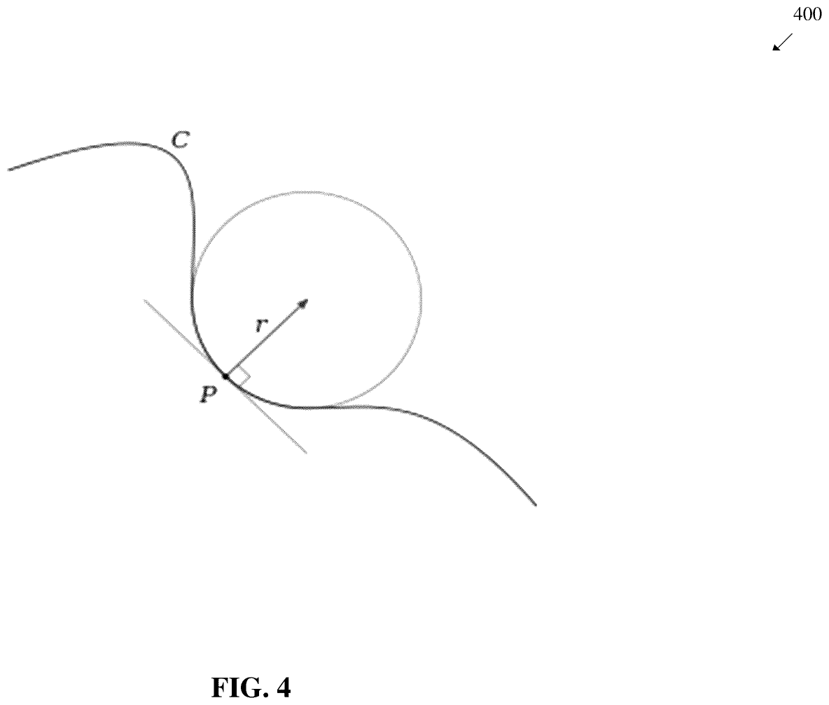

FIG. 4 illustrates an example 400 showing a curvature C. Intuitively, the curvature C is the reciprocal of the radius r of the sphere that best matches the curve, locally.

Regarding edge categorization, an edge can also be categorized in multiple ways, from a variety of standpoints. One simple way of labeling edges is by looking at the vertices at the two ends, giving rise to either ‘face-to-face’, ‘face-to-edge’, ‘face-to-vertex’, ‘edge-to-vertex’, or ‘vertex-to-vertex’ type edge. Given an edge:

$${E}_{j} = [ {V}_{j -} , {V}_{j +} ] ,$$

a local measure of curvature can be assigned to this edge by taking a finite difference derivative of the shading normal N̅_̅{̅S̅}̅,

$${k}_{j} = ‖ \overline{{N}_{{j}_{+}}^{S}} - \overline{{N}_{{j}_{-}}^{S}} ‖ / ‖ \overline{{P}_{j +}} - \overline{{P}_{j -}} ‖$$

### Model Operations Orchestrator for Digital Asset Processing

According to various embodiments herein, a model operations orchestrator for digital asset processing is described that is an efficient tool that makes it easy to customize a variety of processes to be run on a digital asset which can include streamlining the process of optimizing and converting digital assets, particularly large 3D assets. The orchestrator herein functions as a communication layer between multiple containers and an umbrella for various scripts and provides an interface that makes it easy for users to select and perform a custom sequence of tasks on these assets. That is, the model operations orchestrator services are in charge of running all tasks related to manipulation of the digital assets, listening to asset management platform requests, and scheduling the required tasks to process them.

Illustratively, certain aspects of the techniques described herein may be performed by hardware, software, and/or firmware, such as in accordance with the various processes and components described herein, which may contain computer executable instructions executed by the processor 220, such as model operations orchestrator process 248, and/or associated hardware components to perform functions relating to the techniques described herein.

Operationally, and as described in greater detail below, key benefits of the model operations orchestrator are based in part on housing numerous tools that simplify complex tasks such as file format conversions, optimizations for 3D assets, and generating image captures of 3D models (renders), among others. The model operations orchestrator herein is equipped to support Object Storage Services, making it compatible with services like Amazon's S3 or Google's GCP Cloud Storage, and can also facilitate effective third-party communication. These services can be linked together to execute complex workflows, hence enhancing efficiency, whereas the model operations orchestrator provides a customizable system allowing users to perform a sequence of tasks on their assets, which can be defined according to their unique needs. As described herein, the design of the model operations orchestrator ensures that tasks run sequentially, preventing any possible collisions or issues that may arise from parallel execution. Note also that there is an option to add global callbacks at the pipeline level, enabling the tracking of task metrics and providing opportunities for additional third-party integrations as additional containers.

As an example of use of the model operations orchestrator herein, suppose a user needs to download a file from GCP Cloud Storage, optimize it, and then upload the result to AWS S3. This complex workflow can be simplified and automated using the task modules of the model operations orchestrator described herein. In particular, the model operations orchestrator ensures utility to all users, regardless of the tasks' implementation, and provides all necessary tools to access its functions, making it a versatile addition to anyone's 3D asset management toolkit.

Rather than being tied to any particular optimizer, the model operations orchestrator acts as a task handler for multiple images and containers allowing for easy bolt-on of any new services. For example, assume a particular optimizer that cannot ingest STEP files, but another program (e.g., Pixyz) optimizes and converts STEP exceptionally well. The model operations orchestrator herein allows a user to easily plugin Pixyz to the cloud so they could run a STEP file through Pixyz to get a retopologized FBX, then run that FBX through the particular optimizer to get a further optimized GLB and USDZ to instantly publish on the web. In this scenario, for instance, the model operations orchestrator manages the flow of everything that is going on using an “intelligent layer” written above the images and containers so a server or handler (either one would work) could be in touch with the different steps housed in separate containers no matter which images or containers were used to process the file.

In general, the model operations orchestrator herein has three services:
server: An HTTP API to schedule pipeline execution jobs (e.g., the only thing that connects with the outside world).
modules: sets of pre-configured container images, each built with its own set of programs and dependencies, that follow a specific communication contract to interact with Orchestrator to process the 3D and/or 2D files.
Orchestrator: listening for a pipeline definition, spinning up the required architecture and scheduling modules to work on the assets in series or parallel. It is isolated from the outside world.

The model operations orchestrator herein works as a task runner that accepts work definitions from third parties. For an asset management platform like VNTANA, the server exposes a cloud native HTTP API that can schedule Pipelines through the consumption of Pipelines Definitions, that instruct the orchestrator what set of containers should be created to work on the asset. Illustrative defined tasks may be such as:
1. Download the asset from GCP CloudStorage.
2. (Optional) uncompress the asset.
3. Convert the asset to glb.
4. (Optional) Run the asset through Model Prep to apply transformations.
5. Optimize the asset.
6. Generate the thumbnail.
7. Convert to FBX.
8. Convert to USDZ.
9. (Optional) apply Draco compression to the optimized asset.
10. Gather metrics.
11. Upload USDZ, FBX, and GLB versions of the asset.

Notably, this example workflow suits an illustrative asset management platform such as VNTANA, but may differ for other companies and associated asset management platforms. For example, certain users may want to store files in AWS S3, or certain customers may not need all asset versions or else may want to process multiple assets together.

The model operations orchestrator herein uses “Pipeline Definitions”-JSON or YAML manifests describing the work to be performed on the assets-to address different needs. All Pipelines define Tasks that execute different Modules through a standard interface which can run in series or in parallel.

The previous steps use Tasks that call different Modules, such as ones to download/upload assets, convert to GLB, optimize meshes, etc. Modules are individual Container images that expose an interface that allows it to receive from the orchestrator:
1. Read/Write access to the global pipeline step.
2. Specific configuration to execute its task.

Note that “interface” as used above implies the entrypoint (or process) exposed by the container image.

The handler can also receive information from the modules such as “complete” or error messages.

The orchestrator loads Modules dynamically based on the PipelineDefinition. Modules are independent, so features can be added by creating more. Third parties could also create Modules referenced at runtime in Pipeline Definitions.

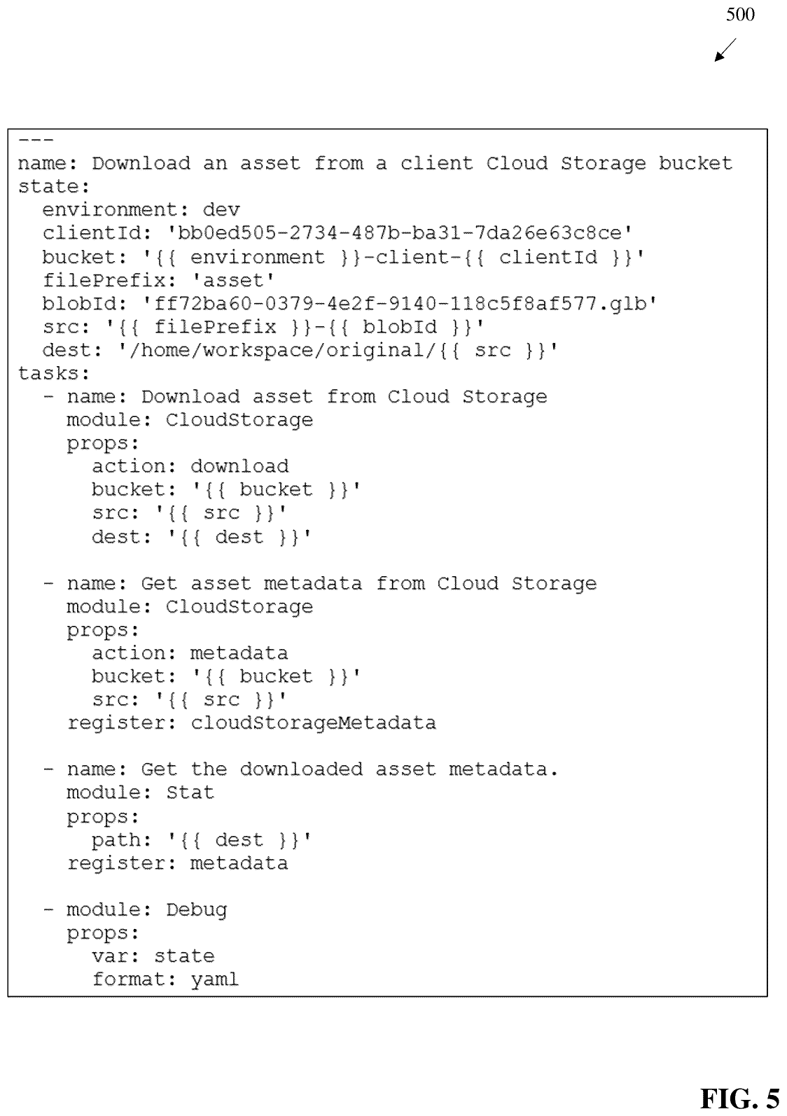

FIG. 5 illustrates an example Pipeline Definition 500. This pipeline will attempt to:
1. Download an asset from GCP Cloud Storage.
2. Get the asset metadata from GCP Cloud Storage.
3. Get further details from the asset by running the stat system call.
4. Print the pipeline state to stdout.

Notice that each pipeline includes a global state where dynamic information can be provided without breaking the Tasks cohesion. The use of variables (values surrounded by brackets {{ }}) allows users to generate multi-use pipelines that can be used for multiple assets just by updating the state values before executing the pipeline.

Another component of the model operations orchestrator architecture is the Scheduler. This is a dynamic element of the model operations orchestrator that configures where the orchestrator container will execute. Generally, the modules can run anywhere, but certain configurations may have other requirements to run their containers (e.g., that the architecture of the worker node is ARM).

The techniques herein could run the server with the docker scheduler to run optimization jobs locally on a single machine. Alternatively, the techniques herein could configure it with the kubernetes scheduler to run optimization jobs on Pods inside the cluster, as may be appreciated by those skilled in the art. As with Modules, each scheduler is completely independent from each other, and the techniques herein can create new ones to support other environments like Google Cloud Run, or AWS Fargate, and so on.

Illustratively, the model operations orchestrator, or “orchestrator” herein, is a service that acts as an orchestrator to schedule, through the scheduler, each individual Module that performs transformations on digital assets. It offers a task-based interface that allows users to specify the tasks to be performed on an asset by each Module. Its design philosophy is to be completely neutral regarding the implementation of the tasks and provide the necessary tools to access its internal functions.

Below is a list of Modules for optimizing 3D assets, in particular, that are exposed by the model operations orchestrator herein:
MeshOptimizer: A tool for optimizing GLB assets with no loss in visual quality;
FBX2GLTf: Converts FBX files to GLB format;
GIF2GLB: Converts GITF files to GLB format;
GITF2USD: Converts GITF/GLB files to USD or USDZ formats;
OBJ2GITF: Converts OBJ files to GLB format;
STL2OBJ: Converts STL files to OBJ format;
ThumbnailGenerator: Generates image captures of 3D models utilizing a 3D Viewer; and
USD2GITF: Converts USD and USDZ files to GLB format.

The model operations orchestrator herein also exposes additional tools to simplify file management, including support for Object Storage Services such as S3 or GCP Cloud Storage, and third-party communication.

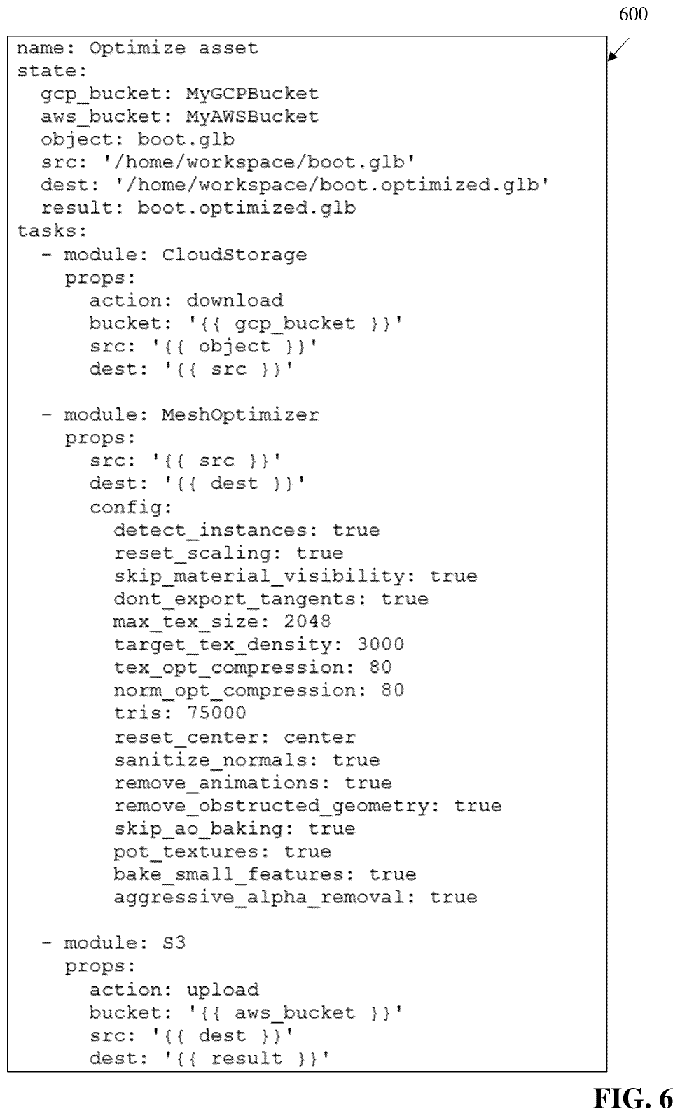

Illustratively, all of these services are exposed through modules that can be chained together to perform complex workflows. FIG. 6 illustrates an example 600 of how one might download, optimize, and upload the resulting file from GCP Cloud Storage to AWS S3.

According to one or more embodiments of the present disclosure, inner workings of the model operations orchestrator herein may be based in part on the execution of pipelines. Pipelines are composed of a sequence of Tasks represented as a list. Each Pipeline can contain multiple Tasks that will run in sequence or parallel. Tasks define a unit of work that needs to be completed on an Asset. The primary parameters of a Pipeline are:
“name”: An optional name for the Pipeline.
“state”: A custom dictionary of values that can be referenced in the pipeline or plugin section.
“tasks”: A list of tasks to be executed on the Asset.
“callbacks”: An object where all global callbacks are defined.
“plugins”: Custom modules that can modify how the Pipeline runs at runtime.
“retries”: Flag that tracks if the module should be retried on error.
“when”: A condition that must be matched for the tasks to execute.
“throw”: Flag tracking whether the task should make the entire Pipeline Execution fail on error or not.

“results”: A key where the output of the module will be stored to be referenced by other tasks.

The “tasks” section is vital, and is where the techniques herein allow specifying how the model operations orchestrator should process the Asset. Each Task invokes a specific module that consumes the following parameters:
A name to describe the task.
The name of the module to be used.
Properties that define the module's behavior. For example, the Fbx2Gltf module sends the options it receives to the fbx2gltf process.
An input and output to indicate the files or directories to work with. If this information is not provided, the module may automatically populate this data.
A callbacks object to configure additional actions that may take place upon a new event.
A register key to store the module's output on the state for another task to consume.
A when expression to control whether the task should execute or be skipped.
A throw flag (set to true by default) that stops the execution of the pipeline if an error is encountered through its execution.

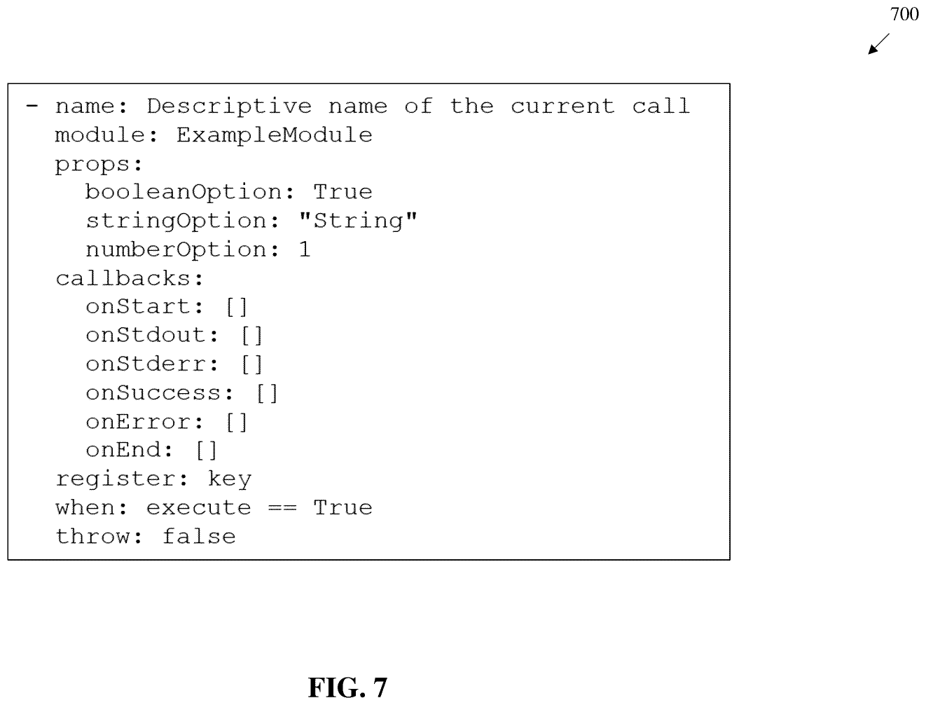

FIG. 7 illustrates an example of a complete Module call 700.

When creating tasks, users should consider defining if they must run sequentially or if it is possible to run them in parallel. Users may choose to skip tasks or continue executing tasks if one fails. Also, callbacks created for a task are side modules that get invoked when certain events get triggered by each module. For example, each module exposes an ‘onStart’, ‘onEnd’, ‘onSuccess’, and ‘onFailure’ event, indicating at what moment of their execution they are. Users can hook ‘callbacks’ to this event to provide additional communication with other third parties, like Slack, or a Webhook service.

Plugins function at the Pipeline level before executing any Task. Users can use Plugins to add additional functionality to a Pipeline and simplify its definition by avoiding redundant configurations. For instance, if a user wants to compute the time required for a Task to execute, they can:
Add an onStart callback that saves an initial timestamp to the State.
Add an onEnd callback that calculates the difference between the initial timestamp and the current time and stores the results back in the State.
Add a global onEnd callback to send the metrics to a third-party service.

Rewriting this for every Task would be time-consuming. Instead, according to the techniques herein, users can create a Plugin that iterates through all of the Tasks and adds the necessary callbacks to each.

According to one or more embodiments of the present disclosure, the model operations orchestrator for digital assets has an abstract orchestrator core. With a flexible architecture, the orchestrator operates on a highly adaptable core framework, continuously scanning the API for new CRDs (Custom Resource Definitions), based on a unique asset recognition algorithm. It efficiently maps out tasks based on the type of digital asset-be it 3D models, videos, images, or audio. Also, through dynamic pipeline ingestion, the orchestrator herein is not limited to specific pipeline structures. Instead, it is capable of ingesting various pipelines tailored for specific digital assets, allowing for diverse processing mechanisms. That is, the techniques herein offer pipeline ingestion with asset-adaptive mechanisms, where instead of a generic approach, the orchestrator uses a newly defined methodology to adaptively select pipelines for digital assets, making processing mechanisms more efficient and accurate.

The container orchestration system is designed from the ground up to offer a platform-agnostic approach. By conceptualizing each processing task-be it 3D asset optimization, 2D image rendering, 360-video rendition, or video compression—as a self-contained module or node, the techniques herein can ensure flexibility, scalability, and ease of integration for a wide range of tasks.

Key features and functionalities of the illustrative model operations orchestrator herein include the following:
Modular Architecture:
   Dynamic Task Nodes: Each processing task is encapsulated within its node, functioning as a stand-alone unit with its defined inputs, processes, and outputs.
   Plug-and-Play: Nodes can be introduced or removed from the system without any disruption to existing processes. This ensures scalability and future-proofs the system against emerging technologies or processing needs.
Unified Interface:
   Standardized Communication: Every node, regardless of its function, communicates using a standardized protocol, ensuring seamless interaction between the orchestrator and the nodes.
   Configuration and Control: Through this interface, users can define parameters, set processing preferences, or even change the processing order based on asset type or desired outcome.
Resource Allocation and Scalability:
   Dynamic Allocation: The orchestrator intelligently allocates resources to nodes based on the complexity and demand of the task. For instance, 3D asset optimization might require more computational power than basic image rendering. That is, advanced container scheduling with asset-specific resource allocation is provided herein where a bespoke algorithm evaluates the asset type and intricacies, allocating container resources in an unprecedentedly precise manner, maximizing efficiency.
   Elastic Scaling: During periods of high demand, the orchestrator can spin up additional instances of a node to handle the load and scale down when demand subsides, optimizing resource use.
Task Pipelining and Parallel Processing:
   Sequential and Parallel Modes: Assets can be processed sequentially through multiple nodes (e.g., 2D rendering followed by video compression) or in parallel (e.g., multiple assets undergoing the same process simultaneously).
   Dependency Resolution: The orchestrator can determine if one task needs to wait for another to finish or if they can be run concurrently, optimizing the flow and reducing processing time.
Error Handling and Recovery:
   Fault Tolerance: Should a node encounter an error, the orchestrator can either retry the task, skip it, or divert it to another similar node if available.
   Real-time Monitoring: Continuous monitoring allows for immediate identification of bottlenecks or failures, with alerts and notifications sent to administrators for swift resolution.
Customizability and Extensibility:
   Custom Nodes: Organizations or individuals can develop their nodes for proprietary or unique processing tasks, then seamlessly integrate them into the orchestration system.
   Open API: An open API approach ensures that third-party developers can leverage our orchestrator's capabilities, encouraging community-driven enhancements and extensions.
Security and Isolation:
   Container Security: Each node operates within its secure container environment, ensuring data privacy and preventing any potential interference with other processes.
   Data Sanitization: Post-processing, temporary data used or generated by the nodes is purged, ensuring no residual data leaks or security vulnerabilities.

The model operations orchestrator herein uses advanced container scheduling and resource allocation, such as individualized container creation and dynamic allocation. For instance, with an emphasis on flexibility, every task is compartmentalized into individual containers. This modular approach ensures efficient resource allocation, superior migration capabilities, and easy upgrades and modifications. Moreover, regarding dynamic allocation, the system herein evaluates the nature of the digital asset in real-time, predicts the resource needs, and adjusts allocations accordingly.

The model operations orchestrator herein also provides for a secure and efficient volume management system. An encryption mechanism protects the integrity and confidentiality of the digital assets, where all data transferred through shared volumes is encrypted. That is, certain embodiments of the techniques herein offer secure data transfer with a newly defined encryption algorithm, where instead of standard encryption mechanisms, a uniquely designed encryption method is employed for superior data protection. Also, for life-cycle management, volumes may be created temporarily for tasks and are managed based on user-defined policies for optimal storage utility.

Adaptive and resilient mechanisms are also a key focus of the model operations orchestrator herein. Automated detection and correction are offered by the orchestrator herein, where based on inherent rules and conditions, the orchestrator detects anomalies and proactively rectifies potential issues, ensuring continuous and seamless processing. Also, every executed task provides insights, enabling continuous refinement of the orchestration process (e.g., a feedback loop).

The model operations orchestrator herein also provides for intuitive pipeline generation and management, where a repository of pre-defined templates is provided for commonly used processes across different digital assets to ensure rapid deployment. Also, for custom design, users have the tools to craft and tailor pipelines specific to unique requirements, and the system can ingest and execute them with ease.

The model operations orchestrator herein further provides real-time analytics and a comprehensive logging framework. In particular, real-time performance dashboards offer granular insights into processing status, resource utilization, and performance metrics for every digital asset type. Also, a holistic centralized logging mechanism consolidates logs from all containers, ensuring efficient troubleshooting and performance analysis.

According to prioritized execution control of the model operations orchestrator herein, and given the diverse nature of digital assets, task prioritization can take place where users can define execution priorities, ensuring critical assets are processed first.

The model operations orchestrator herein offers universal integration and compatibility, through multi-cloud orchestration and interoperability. For example, though an illustrative embodiment herein has the system core being built around a containerized system such as Kubernetes, the orchestrator is equipped with plugins and extensions that allow for execution across various cloud platforms. Further, the orchestrator is designed to integrate seamlessly with various processing tools specific to different digital asset types. Moreover, when integrating custom nodes, the system herein can perform a compatibility pre-analysis, where before integrating such custom nodes, a compatibility and efficiency assessment may be conducted to ensure optimal performance within the orchestrator environment.

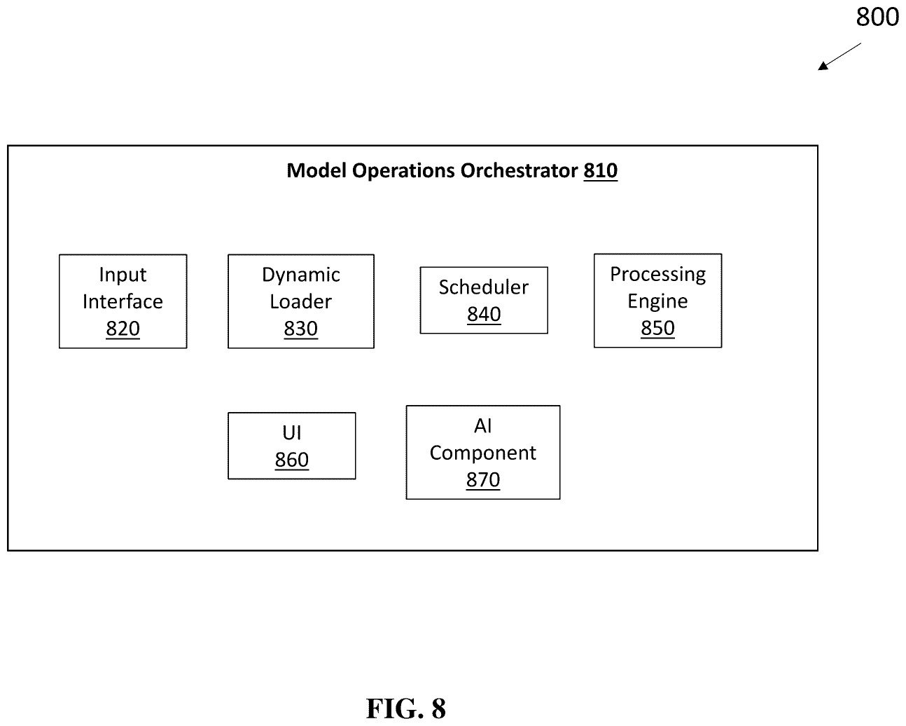

FIG. 8 is an example simplified architecture of a system 800 (e.g., an apparatus, comprising one or more devices operating in tandem) for orchestrating model operations for digital asset processing. In particular, the system 800 may comprise:
a model operations orchestrator 810 configured to function as a communication layer between a plurality of containerized environments, wherein each containerized environment houses one or more modules configured to perform specific tasks on a digital asset;
an input interface 820 configured to receive a definition of an orchestration pipeline, the orchestration pipeline specifying a sequence of tasks to be performed on the digital asset, each task corresponding to a particular module within a particular containerized environment;
a dynamic loader 830 configured to dynamically load one or more pipeline modules based on the orchestration pipeline, wherein each pipeline module exposes an interface that allows the model operations orchestrator to provide specific configuration parameters required for execution of a corresponding task for that pipeline module;
a scheduler 840 configured to schedule execution of the one or more pipeline modules in accordance with the orchestration pipeline, wherein the one or more pipeline modules are executed either sequentially or in parallel based on the sequence of tasks and without collision; and
a processing engine 850 configured to process the digital asset through the sequence of tasks as defined in the orchestration pipeline, wherein the digital asset is managed by the model operations orchestrator as a single manifest asset that is handled throughout the orchestration pipeline.

It will be apparent to those skilled in the art that other configurations, including more or fewer components, may be used in accordance with the techniques herein, and that the architectural view above is merely functionally representative of features of the techniques herein. Further, where certain processes/components have been shown separately, those skilled in the art will appreciate that processes/components may be portions within other processes.

Moreover, the user-centric interface of the model operations orchestrator herein may also comprise an interactive user interface (UI 860), namely a “drag-and-drop” interface that ensures even non-technical users can design, monitor, and manage their asset processing pipelines effortlessly. For example, the various functions or features or operations may be graphically represented as blocks from available libraries that can be dragged into a UI and interconnected (linked) in a particular order to establish the desired pipeline(s), with variables entered through customized configurations (such as folder locations, variable values, and so on). Tool integrations may also be provided by the orchestrator for popular CI/CD tools, version control systems, and other relevant utilities for a comprehensive user experience.

The model operations orchestrator herein is also a scalable and modular design, where a stable core handles orchestration while extensions can be added to augment capabilities or support new digital asset types. The system's future-ready design also ensures it can accommodate emerging digital asset formats and processing needs with minimal adjustments.

According to one or more additional embodiments of the model operations orchestrator herein, AI-driven orchestration offers transformative capabilities for the systems herein. For instance, by analyzing historical data and patterns, artificial intelligence (AI) and machine learning (ML) can use predictive analysis to preemptively schedule tasks, optimize resource allocation, and forecast potential bottlenecks or system stresses, adjusting orchestration strategy accordingly. For instance, beyond generic orchestration, the system herein may employ a unique node allocation algorithm to determine the ideal allocation of tasks to nodes, based on historical data and predictive analytics related to digital asset types.

Furthermore, over time, an AI component 870 of the orchestrator can learn from the outcomes of orchestrated tasks, refining its strategies to ensure maximum efficiency and optimal processing of digital assets. For instance, self-optimizing capabilities are designed where each processing task's node has an in-built self-assessment mechanism that continuously refines its operation based on previous outcomes and feedback. Note, too, that by using AI-enhanced orchestration with continuous learning loops, the system herein need not merely optimize operations, but may also continuously learn from each asset processed, refining its orchestration methodologies over time. This includes predictive task scheduling, resource forecasting, and even auto-generation of optimal pipelines for new or unique asset types.

For smart troubleshooting, in the case of errors or failures, an AI-driven orchestrator herein could quickly diagnose the root cause, suggest remedies, and/or automatically implement corrective actions. That is, error handling herein may be based on proactive root-cause analysis, such that when errors occur, the system herein may do more than simply retry or divert, but rather may conduct an AI-driven root-cause analysis to prevent future occurrences of the same error.

According to additional AI-based features of the model operations orchestrator herein, automated pipeline crafting may be provided, where AI algorithms suggest or create optimized pipelines based on the specific attributes and requirements of each digital asset, ensuring that each asset is processed in the most efficient manner possible. That is, apart from standard configuration, users can employ a proprietary machine learning-based recommendation system to enhance processing preferences for optimal results. For example, task pipelining with dependency-optimized flows may be established where, beyond mere sequential or parallel processing, the orchestrator uses an AI-backed algorithm to decide the ideal flow of assets through nodes, considering complex inter-dependencies.

Additionally, resource forecasting can be achieved where AI can be used to predict future resource requirements based on patterns, asset types, and the evolution of technologies, enabling proactive system scaling and infrastructure planning. Such intelligent resource allocation with predictive scaling may use a combination of machine learning and heuristic analysis, such that resources are not just dynamically allocated, but future requirements are predicted and resources are pre-allocated to anticipate needs.

Advantageously, the techniques herein provide for a model operations orchestrator for digital asset processing. In particular, as noted above, digital assets, and particularly 3D models, are often large and complex (e.g., not just a binary file, but often a set of functions that define a model), and many different outputs are often needed from an original asset (e.g., 3D model). According to the present disclosure, therefore, a user can now define any flow they want in order to manage and manipulate the asset (e.g., optimize, convert, compress, sanitize, render, store, etc.) in a customizable pipeline based on core building blocks, cloud-based tools, and an intelligent layer of asset management between the stages of the pipeline, accordingly. Now, with a customized pipeline aligned with user desires, files/assets can easily be input into the pipeline to produce any number of configured outputs.

Furthermore, passing the asset through the steps of a pipeline is complex, and takes lots of time. Cloud-native solutions do not currently exist to pass an entire file or folder as is often needed for complex assets like 3D models. They also do not have the ability to orchestrate multiple containers of various processes. The techniques herein thus allow for the large asset (artifact) in its entirety to be managed as a single manifest file that is handled accordingly, with an intelligent layer interweaved throughout the pipeline to listen to and communicate between the ordered nodes (e.g., container images) to pass and process the large asset (e.g., file, image, video, etc., 3D or otherwise). Additionally, the digital asset processing orchestrator herein offers asset-driven allocation and AI-optimized workflows not currently available in conventional systems.

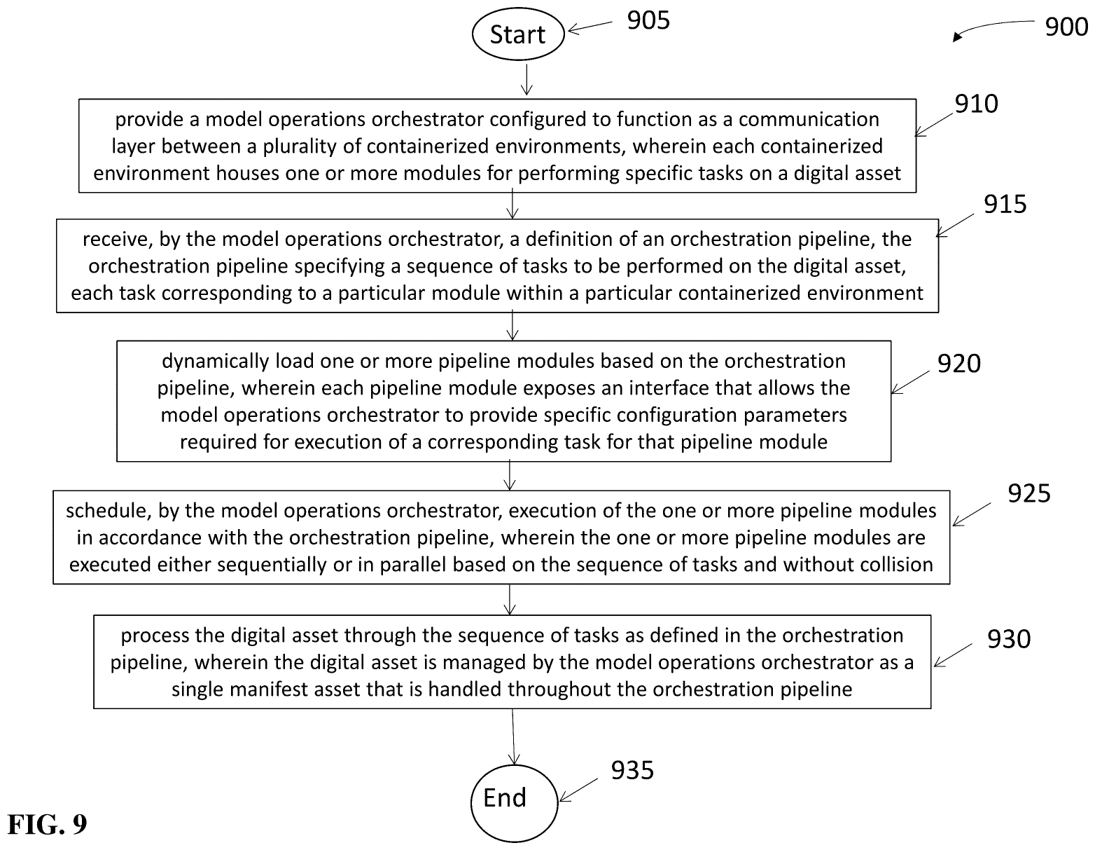

FIG. 9 illustrates an example simplified procedure (procedure 900) for operation of a model operations orchestrator for digital asset processing according to one or more aspects of the present disclosure. Procedure 900 (e.g., a method) may be performed by one or more processing devices (e.g., an apparatus, a system, a configured computer, server, software as a service (SaaS), and so on), and may start in step 905.

In step 910, the techniques herein may provide a model operations orchestrator configured to function as a communication layer between a plurality of containerized environments, wherein each containerized environment houses one or more modules for performing specific tasks on a digital asset.

In step 915, the techniques herein may receive, by the model operations orchestrator, a definition of an orchestration pipeline, the orchestration pipeline specifying a sequence of tasks to be performed on the digital asset, each task corresponding to a particular module within a particular containerized environment;

In step 920, the techniques herein may dynamically load one or more pipeline modules based on the orchestration pipeline, wherein each pipeline module exposes an interface that allows the model operations orchestrator to provide specific configuration parameters required for execution of a corresponding task for that pipeline module;

In step 925, the techniques herein may schedule, by the model operations orchestrator, execution of the one or more pipeline modules in accordance with the orchestration pipeline, wherein the one or more pipeline modules are executed either sequentially or in parallel based on the sequence of tasks and without collision; and

In step 930, the techniques herein may process the digital asset through the sequence of tasks as defined in the orchestration pipeline, wherein the digital asset is managed by the model operations orchestrator as a single manifest asset that is handled throughout the orchestration pipeline.

The procedure 900 may then end in step 935.

Other steps may be included within the procedure 900, and those shown above are merely one representative example herein. For instance, procedure 900 may include additional steps, or sub steps within the steps noted above, such as, for example: producing a plurality of configured outputs; providing an interactive drag-and-drop user interface; performing a compatibility pre-analysis on custom nodes before integrating the custom node into the orchestration pipeline; dynamically allocating resources to nodes; forecasting resource requirements; providing prioritized execution control;
providing real-time analytics/logging; performing responsive actions to problems;
analyzing historical data and patterns for predictive analysis to adjust the orchestration pipeline; refining the orchestration pipeline (e.g., according to AI/ML); and others as described in greater detail herein.

While there have been shown and described illustrative embodiments, it is to be understood that various other adaptations and modifications may be made within the spirit and scope of the embodiments herein. For example, the embodiments described herein may be used with other suitable digital asset processing technologies or file formats, and those shown herein are merely examples. Also, while the embodiments have been generally described in terms of 3D models (including static images, holographic images, or video images), other types of digital assets may benefit from the techniques herein, such as files, folders, and so on.

Moreover, the embodiments herein may generally be performed in connection with one or more computing devices (e.g., personal computers, laptops, servers, specifically configured computers, cloud-based computing devices, cameras, mobile phones, etc.), which may be interconnected via various local and/or network connections. Various actions described herein may be related specifically to one or more of the devices, though any reference to particular type of device herein is not meant to limit the scope of the embodiments herein.

According to one or more embodiments herein, an illustrative method herein may comprise: providing a model operations orchestrator configured to function as a communication layer between a plurality of containerized environments, wherein each containerized environment houses one or more modules for performing specific tasks on a digital asset; receiving, by the model operations orchestrator, a definition of an orchestration pipeline, the orchestration pipeline specifying a sequence of tasks to be performed on the digital asset, each task corresponding to a particular module within a particular containerized environment; dynamically loading one or more pipeline modules based on the orchestration pipeline, wherein each pipeline module exposes an interface that allows the model operations orchestrator to provide specific configuration parameters required for execution of a corresponding task for that pipeline module; scheduling, by the model operations orchestrator, execution of the one or more pipeline modules in accordance with the orchestration pipeline, wherein the one or more pipeline modules are executed either sequentially or in parallel based on the sequence of tasks and without collision; and processing the digital asset through the sequence of tasks as defined in the orchestration pipeline, wherein the digital asset is managed by the model operations orchestrator as a single manifest asset that is handled throughout the orchestration pipeline.

In one embodiment, the sequence of tasks are selected from a group consisting of: downloading the digital asset, uncompressing the digital asset, converting a format of the digital asset, reconverting a converted digital asset into an additional format, transforming the digital asset, optimizing the digital asset, sanitizing the digital asset, generating a thumbnail of the digital asset, compressing the digital asset, rendering the digital asset, gathering metrics on the digital asset, storing the digital asset, uploading the digital asset, and uploading a plurality of versions of the digital asset.

In one embodiment, the digital asset is selected from a group consisting of: a visual digital asset, an audio digital asset, a file, a folder, a static image, a two-dimensional image, a three-dimensional image, a holographic image, a video, a three-dimensional video, and a three-dimensional model.

In one embodiment, a single digital asset input into the orchestration pipeline produces a plurality of configured outputs.

In one embodiment, the orchestration pipeline is a multi-use pipeline that can be reused for multiple digital assets by updating state values of variables within the orchestration pipeline before executing the orchestration pipeline. In one embodiment, the method further comprises: providing a plugin that iterates through all tasks of the sequence of tasks and adds user-defined adjustments to each task.

In one embodiment, the orchestration pipeline is generated based on a user input. In one embodiment, the method further comprises: providing an interactive drag-and-drop user interface to receive the user input for designing, monitoring, and managing the orchestration pipeline, wherein various functions, features, or operations are graphically represented as blocks from available libraries, which can be dragged into a user interface and interconnected in a particular order to establish the orchestration pipeline, with variables entered through customized configurations. In one embodiment, the method further comprises: providing a repository of pre-defined templates for a set of orchestration pipelines for processing digital assets.

In one embodiment, the method further comprises: allowing nodes to be introduced or removed from the orchestration pipeline without disruption to existing executions.

In one embodiment, the method further comprises: receiving a request to integrate a custom node into the orchestration pipeline; and performing a compatibility pre-analysis on the custom node before integrating the custom node into the orchestration pipeline.

In one embodiment, the orchestration pipeline is generated based on an artificial intelligence input programmed to generate optimized pipelines based on specific attributes and requirements of the digital asset.

In one embodiment, the method further comprises: configuring the orchestration pipeline based on a type of the digital asset.

In one embodiment, the method further comprises: dynamically allocating resources to nodes based on a complexity and demand of the sequence of tasks and a nature of the digital asset.

In one embodiment, the method further comprises: forecasting resource requirements for the model operations orchestrator based on patterns, asset types, and technology evolution to enable proactive system scaling and infrastructure planning.

In one embodiment, the method further comprises: providing prioritized execution control through task prioritization, ensuring that critical digital assets are processed first.

In one embodiment, the method further comprises: determining whether a first task of the sequence of tasks needs to wait for a second task of the sequence of tasks to finish or if the first task and the second task can be run concurrently; and orchestrating the first task and the second task based thereon.

In one embodiment, the method further comprises: receiving, by the model operations orchestrator, status updates from the one or more pipeline modules, including completion notifications and error messages; and adjusting execution of the orchestration pipeline according to the status updates.

In one embodiment, the method further comprises: providing global callbacks to the orchestration pipeline for tracking task metrics.

In one embodiment, the method further comprises: providing real-time analytics of processing status, resource utilization, and performance metrics correlated to particular types of digital assets.

In one embodiment, the method further comprises: providing a centralized logging mechanism that consolidates logs from all containers within the orchestration pipeline.

In one embodiment, the method further comprises: detecting an encountered problem within execution of the orchestration pipeline; determining a responsive action for the encountered problem selected from a group consisting of: retrying a given task, skipping the given task, diverting the given task to another similar node if available, and reporting the encountered problem; and performing the responsive action.

In one embodiment, the method further comprises: analyzing historical data and patterns of the orchestration pipeline over time; and using predictive analysis based on analyzing to adjust the orchestration pipeline.

In one embodiment, adjusting the orchestration pipeline comprises one or more of: preemptively scheduling tasks, optimizing resource allocation, forecasting potential bottlenecks, and forecasting system stresses.

In one embodiment, the method further comprises: refining the orchestration pipeline according to a self-optimization mechanism based on assessment of previous results from the orchestration pipeline. In one embodiment, the method further comprises: conducting an artificial intelligence-driven root-cause analysis to prevent future occurrences of an experienced error.

In one embodiment, the sequence of tasks are executed on local environments, cloud environments, or a combination of both.

According to one or more embodiments herein, an illustrative tangible, non-transitory, computer-readable medium herein may store program instructions that cause a device to execute a process comprising: providing a model operations orchestrator configured to function as a communication layer between a plurality of containerized environments, wherein each containerized environment houses one or more modules for performing specific tasks on a digital asset; receiving, by the model operations orchestrator, a definition of an orchestration pipeline, the orchestration pipeline specifying a sequence of tasks to be performed on the digital asset, each task corresponding to a particular module within a particular containerized environment; dynamically loading one or more pipeline modules based on the orchestration pipeline, wherein each pipeline module exposes an interface that allows the model operations orchestrator to provide specific configuration parameters required for execution of a corresponding task for that pipeline module; scheduling, by the model operations orchestrator, execution of the one or more pipeline modules in accordance with the orchestration pipeline, wherein the one or more pipeline modules are executed either sequentially or in parallel based on the sequence of tasks and without collision; and processing the digital asset through the sequence of tasks as defined in the orchestration pipeline, wherein the digital asset is managed by the model operations orchestrator as a single manifest asset that is handled throughout the orchestration pipeline.

According to one or more embodiments herein, an illustrative apparatus for orchestrating model operations for digital asset processing may comprise: a model operations orchestrator configured to function as a communication layer between a plurality of containerized environments, wherein each containerized environment houses one or more modules configured to perform specific tasks on a digital asset; an input interface configured to receive a definition of an orchestration pipeline, the orchestration pipeline specifying a sequence of tasks to be performed on the digital asset, each task corresponding to a particular module within a particular containerized environment; a dynamic loader configured to dynamically load one or more pipeline modules based on the orchestration pipeline, wherein each pipeline module exposes an interface that allows the model operations orchestrator to provide specific configuration parameters required for execution of a corresponding task for that pipeline module; a scheduler configured to schedule execution of the one or more pipeline modules in accordance with the orchestration pipeline, wherein the one or more pipeline modules are executed either sequentially or in parallel based on the sequence of tasks and without collision; and a processing engine configured to process the digital asset through the sequence of tasks as defined in the orchestration pipeline, wherein the digital asset is managed by the model operations orchestrator as a single manifest asset that is handled throughout the orchestration pipeline.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
providing a model operations orchestrator configured to function as a communication layer between a plurality of containerized environments, wherein each containerized environment houses one or more modules for performing specific tasks on a digital asset;
receiving, by the model operations orchestrator, a definition of an orchestration pipeline, the orchestration pipeline specifying a sequence of tasks to be performed on the digital asset, each task corresponding to a particular module within a particular containerized environment;
dynamically loading one or more pipeline modules based on the orchestration pipeline, wherein each pipeline module exposes an interface that allows the model operations orchestrator to provide specific configuration parameters required for execution of a corresponding task for that pipeline module;
scheduling, by the model operations orchestrator, execution of the one or more pipeline modules in accordance with the orchestration pipeline, wherein the one or more pipeline modules are executed either sequentially or in parallel based on the sequence of tasks and without collision; and
processing the digital asset through the sequence of tasks as defined in the orchestration pipeline, wherein the digital asset is managed by the model operations orchestrator as a single manifest asset that is handled throughout the orchestration pipeline.

2. The method of claim 1, wherein the sequence of tasks are selected from a group consisting of: downloading the digital asset, uncompressing the digital asset, converting a format of the digital asset, reconverting a converted digital asset into an additional format, transforming the digital asset, optimizing the digital asset, sanitizing the digital asset, generating a thumbnail of the digital asset, compressing the digital asset, rendering the digital asset, gathering metrics on the digital asset, storing the digital asset, uploading the digital asset, and uploading a plurality of versions of the digital asset.

3. The method of claim 1, wherein the digital asset is selected from a group consisting of: a visual digital asset, an audio digital asset, a file, a folder, a static image, a two-dimensional image, a three-dimensional image, a holographic image, a video, a three-dimensional video, and a three-dimensional model.

4. The method of claim 1, wherein a single digital asset input into the orchestration pipeline produces a plurality of configured outputs.

5. The method of claim 1, wherein the orchestration pipeline is a multi-use pipeline that can be reused for multiple digital assets by updating state values of variables within the orchestration pipeline before executing the orchestration pipeline.

6. The method of claim 5, further comprising:
providing a plugin that iterates through all tasks of the sequence of tasks and adds user-defined adjustments to each task.

7. The method of claim 1, wherein the orchestration pipeline is generated based on a user input.

8. The method of claim 7, further comprising:
providing an interactive drag-and-drop user interface to receive the user input for designing, monitoring, and managing the orchestration pipeline, wherein various functions, features, or operations are graphically represented as blocks from available libraries, which can be dragged into a user interface and interconnected in a particular order to establish the orchestration pipeline, with variables entered through customized configurations.

9. The method of claim 7, further comprising:
providing a repository of pre-defined templates for a set of orchestration pipelines for processing digital assets.

10. The method of claim 1, further comprising:
allowing nodes to be introduced or removed from the orchestration pipeline without disruption to existing executions.

11. The method of claim 1, further comprising:
receiving a request to integrate a custom node into the orchestration pipeline; and
performing a compatibility pre-analysis on the custom node before integrating the custom node into the orchestration pipeline.

12. The method of claim 1, wherein the orchestration pipeline is generated based on an artificial intelligence input programmed to generate optimized pipelines based on specific attributes and requirements of the digital asset.

13. The method of claim 1, further comprising:
configuring the orchestration pipeline based on a type of the digital asset.

14. The method of claim 1, further comprising:
dynamically allocating resources to nodes based on a complexity and demand of the sequence of tasks and a nature of the digital asset.

15. The method of claim 1, further comprising:
forecasting resource requirements for the model operations orchestrator based on patterns, asset types, and technology evolution to enable proactive system scaling and infrastructure planning.

16. The method of claim 1, further comprising:
providing prioritized execution control through task prioritization, ensuring that critical digital assets are processed first.

17. The method of claim 1, further comprising:
determining whether a first task of the sequence of tasks needs to wait for a second task of the sequence of tasks to finish or if the first task and the second task can be run concurrently; and
orchestrating the first task and the second task based thereon.

18. The method of claim 1, further comprising:
receiving, by the model operations orchestrator, status updates from the one or more pipeline modules, including completion notifications and error messages; and
adjusting execution of the orchestration pipeline according to the status updates.

19. The method of claim 1, further comprising:
providing global callbacks to the orchestration pipeline for tracking task metrics.

20. The method of claim 1, further comprising:
providing real-time analytics of processing status, resource utilization, and performance metrics correlated to particular types of digital assets.

21. The method of claim 1, further comprising:
providing a centralized logging mechanism that consolidates logs from all containers within the orchestration pipeline.

22. The method of claim 1, further comprising:
detecting an encountered problem within execution of the orchestration pipeline;
determining a responsive action for the encountered problem selected from a group consisting of: retrying a given task, skipping the given task, diverting the given task to another similar node if available, and reporting the encountered problem; and
performing the responsive action.

23. The method of claim 1, further comprising:
analyzing historical data and patterns of the orchestration pipeline over time; and
using predictive analysis based on analyzing to adjust the orchestration pipeline.

24. The method of claim 23, wherein adjusting the orchestration pipeline comprises one or more of: preemptively scheduling tasks, optimizing resource allocation, forecasting potential bottlenecks, and forecasting system stresses.

25. The method of claim 1, further comprising:
refining the orchestration pipeline according to a self-optimization mechanism based on assessment of previous results from the orchestration pipeline.

26. The method of claim 25, further comprising:
conducting an artificial intelligence-driven root-cause analysis to prevent future occurrences of an experienced error.

27. The method of claim 1, wherein the sequence of tasks are executed on local environments, cloud environments, or a combination of both.

28. A tangible, non-transitory, computer-readable medium storing program instructions that cause a device to execute a process comprising:
providing a model operations orchestrator configured to function as a communication layer between a plurality of containerized environments, wherein each containerized environment houses one or more modules for performing specific tasks on a digital asset;
receiving, by the model operations orchestrator, a definition of an orchestration pipeline, the orchestration pipeline specifying a sequence of tasks to be performed on the digital asset, each task corresponding to a particular module within a particular containerized environment;
dynamically loading one or more pipeline modules based on the orchestration pipeline, wherein each pipeline module exposes an interface that allows the model operations orchestrator to provide specific configuration parameters required for execution of a corresponding task for that pipeline module;
scheduling, by the model operations orchestrator, execution of the one or more pipeline modules in accordance with the orchestration pipeline, wherein the one or more pipeline modules are executed either sequentially or in parallel based on the sequence of tasks and without collision; and
processing the digital asset through the sequence of tasks as defined in the orchestration pipeline, wherein the digital asset is managed by the model operations orchestrator as a single manifest asset that is handled throughout the orchestration pipeline.

29. An apparatus for orchestrating model operations for digital asset processing, comprising:
a model operations orchestrator configured to function as a communication layer between a plurality of containerized environments, wherein each containerized environment houses one or more modules configured to perform specific tasks on a digital asset;
an input interface configured to receive a definition of an orchestration pipeline, the orchestration pipeline specifying a sequence of tasks to be performed on the digital asset, each task corresponding to a particular module within a particular containerized environment;
a dynamic loader configured to dynamically load one or more pipeline modules based on the orchestration pipeline, wherein each pipeline module exposes an interface that allows the model operations orchestrator to provide specific configuration parameters required for execution of a corresponding task for that pipeline module;
a scheduler configured to schedule execution of the one or more pipeline modules in accordance with the orchestration pipeline, wherein the one or more pipeline modules are executed either sequentially or in parallel based on the sequence of tasks and without collision; and
a processing engine configured to process the digital asset through the sequence of tasks as defined in the orchestration pipeline, wherein the digital asset is managed by the model operations orchestrator as a single manifest asset that is handled throughout the orchestration pipeline.
